(19) United States
(12) Patent Application Publication
(10) Pub. No.: US 2020/0034868 A1
(43) Pub. Date: Jan. 30, 2020

(54) SYSTEMS AND METHODS FOR ATTRACTING CUSTOMERS WITH DIGITAL REWARDS

(71) Applicant: VALEVO, INC., Valencia, CA (US)

(72) Inventors: Bill MOMARY, Valencia, CA (US); Jonathan BASSETT, Valencia, CA (US); Jason BASSETT, Valencia, CA (US)

(21) Appl. No.: 16/045,585

(22) Filed: Jul. 25, 2018

(51) Int. Cl. G06Q 30/02; G06Q 20/36; G06F 8/61

(52) U.S. Cl. CPC G06Q 30/0229; G06Q 30/0224; G06Q 2220/00; G06Q 30/0215; G06F 8/61; G06Q 20/3678

(57) ABSTRACT

A consumer mobile software application is designed to entice new or infrequent visitors to visit a merchant. The application may permit the consumer to register and receive reward offers from the merchant, typically only when the consumer is at the merchant's place of business. The application may store each of the merchants added to the consumer's account and track the available rewards. The application may also store anywhere dollars, which may be usable across any of the participating merchants. The anywhere dollars may be converted into a crypto currency whose value may fluctuate based on the value of such currency. The merchants accepting such currency when redeemed by the consumer may opt to auto exchange the crypto currency to dollars on their account or may choose to retain the crypto currency itself.

### BACKGROUND OF THE INVENTION

### 1. Field of the Invention

Embodiments of the invention relates generally to systems and methods for attracting customers. More particularly, the invention relates to a mobile application that provides consumers a manner to receive and store rewards issued from merchants.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Several loyalty reward programs exist with the purpose of retaining loyal customers by providing them with certain rewards, typically increasing with increased spending. For example, casinos may provide discount or no-cost lodging for gambling at their casino. Grocery stores may provide a discount based on total dollars spent. Merchants may provide consumers with rewards usable on a future visit when a certain dollar amount is spent. In each of these examples, the consumer is receiving a “loyalty” reward—that is, a reward based on their continued spending with that particular merchant. These types of rewards programs provide little, if any, motivation for a new or infrequent customer to visit that merchant.

Digital wallets and electronic payment methods have been available for several years. These wallets provide consumers a way to make payments by linking one or more accounts to the digital wallet. For example, a consumer may provide a credit card to their digital wallet, where, when payments are made, the digital wallet causes the credit card to be charged for the specified amount. These digital wallets, however, while they may include multiple payment methods, do not track any rewards that consumers have at a particular merchant. While each merchant may have their own software applications for tracking rewards, such applications are typically provided for individual merchants and the consumer does not have a mobile software application for consolidating their rewards.

In view of the foregoing, it is clear that there is a need for a system and method for providing rewards to a consumer that may attract new or infrequent visitors to that business while allowing the consumer to track and review their rewards across a plurality of businesses in a single mobile software application.

### SUMMARY OF THE INVENTION

Embodiments of the present invention provide a method for attracting an infrequent customer to a business comprising prompting the customer to install a software application on a mobile device; sending a notification of a discount offer from a merchant to the mobile device via the software application when the customer is at the merchant when it is determined that the customer visits the merchant infrequently, wherein a determination of whether the customer visits the merchant infrequently is provided by one or more predetermined matrices; storing the discount offer in a wallet of the software application if the customer accepts the discount offer, wherein the wallet is configured to store and compile multiple offers from multiple merchants; and storing anywhere dollars in the wallet of the software application, wherein anywhere dollars are redeemable at any of the multiple merchants of the customer.

Embodiments of the present invention relate to a method of two-way communication leveraging Bluetooth on a mobile phone and a built-in beacon technology on a merchant tablet to facilitate both frictionless transactions and to track device traffic in/out of a business location.

Embodiments of the present invention further provide a mobile software application disposed on a tangible computer readable medium within a mobile device, the software application including program code configured to perform the following steps: prompting the customer to install the software application on the mobile device; sending a notification of a discount offer from a merchant to the mobile device via the software application when the customer is at the merchant when it is determined that the customer visits the merchant infrequently, wherein a determination of whether the customer visits the merchant infrequently is provided by one or more predetermined matrices; storing the discount offer in a wallet of the software application if the customer accepts the discount offer, wherein the wallet is configured to store and compile multiple offers from multiple merchants; storing anywhere dollars in the wallet of the software application, wherein anywhere dollars are redeemable at any of the multiple merchants of the customer; displaying, via the software application, a dashboard page to the consumer, the dashboard page including a view of the total value of the discount offers and anywhere dollars available in an account of the consumer; displaying, via the software application, nearby merchants; displaying, via the software application, a wallet view page showing a value of the discount offers and anywhere dollars available for each merchant added to the wallet; and displaying, via the software application, a merchant details page providing the consumer with information about the merchant and, if the merchant is added to the consumer's wallet, a value of discount offers redeemable at the merchant.

Embodiments of the present invention also provide a method for attracting an infrequent customer to a business comprising prompting the customer to install a software application on a mobile device; sending a notification of a discount offer from a merchant to the mobile device via the software application when the customer is at the merchant when it is determined that the customer visits the merchant infrequently, wherein a determination of whether the customer visits the merchant infrequently is provided by one or more predetermined matrices; storing the discount offer in a wallet of the software application if the customer accepts the discount offer, wherein the wallet is configured to store and compile multiple offers from multiple merchants; storing anywhere dollars in the wallet of the software application, wherein anywhere dollars are redeemable at any of the multiple merchants of the customer; displaying a dashboard page provided by the software application, the dashboard page including a view of the total value of the discount offers and anywhere dollars available in an account of the consumer; displaying a wallet view provided by the software application, the wallet view displaying a value of the discount offers and anywhere dollars available for each merchant added to the wallet; displaying a merchant details page available by the software application, the merchant details page providing the consumer with information about the merchant and, if the merchant is added to the consumer's wallet, a value of discount offers redeemable at the merchant; displaying a redemption page by the software application, wherein the consumer is prompted to enter the total of a transaction and is prompted to apply available discount offers and anywhere dollars to the transaction at the merchant; and periodically sending a digest of discount offers to the consumer via the software application, the discount offers sent to the consumer include merchants at which the consumer visits infrequently.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an exemplary screen shot showing an initial screen that may describe how a user can add a merchant to their application;

FIG. 2 illustrates an exemplary screen shot showing an initial screen that may describe how a user can earn rewards from a merchant;

FIG. 3 illustrates an exemplary screen shot showing an initial screen that may describe the need to use location services to use the user's location in the application;

FIG. 4 illustrates an exemplary screen shot showing where a user has been given an initial offer from a local merchant;

FIG. 5 illustrates an exemplary screen shot showing where a user can complete their first transaction, as shown in FIG. 4, then be required to sign up for the application;

FIG. 6 illustrates an exemplary screen shot showing an example of a sign-in screen;

FIG. 7 illustrates an exemplary screen shot showing an initial screen where the consumer is permitted to add up to a limited number of merchants to their account on the application;

FIG. 8 illustrates an exemplary screen shot showing a user dashboard view, illustrating total dollars available in the user's account and nearby merchants;

FIG. 9 illustrates an exemplary screen shot showing a user dashboard view, illustrating total dollars available in the user's account, nearby merchants and one specific merchant being identified;

FIG. 10 illustrates an exemplary screen shot showing a wallet view, illustrating various merchants where the user has reward dollars available to spend;

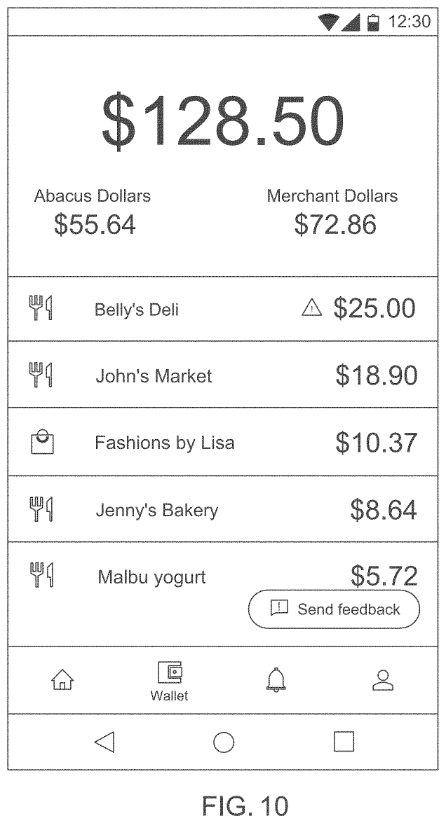

FIG. 11 illustrates an exemplary screen shot showing a merchant detail view after the merchant has been added to the consumer's account;

FIG. 12 illustrates an exemplary screen shot showing a merchant detail view before the merchant is added to the consumer's account;

FIG. 13 illustrates an exemplary screen shot showing a nearby merchant view, illustrating both merchants added to the user's account, and those merchants available to be added to the user's account;

FIG. 14 illustrates an exemplary screen shot showing how a user can redeem available dollars by entering in the total due at the register into the application and adding an appropriate discount based on available dollars;

FIG. 15 illustrates an exemplary screen shot showing how both discount dollars and Abacus dollars may be used at a merchant;

FIG. 16 illustrates an exemplary screen shot showing a periodic digest available to users of the application where merchant offers may be provided for acceptance by the consumer;

FIG. 17 illustrates an exemplary screen shot showing an example of a branching notification provided to a consumer when they visit a merchant they have not added to their account;

FIG. 18 illustrates an exemplary screen shot showing an account summary page available to the user to edit and/or add details to their account registration;

FIG. 19 illustrates an exemplary embodiment of how a discount currency is stored and transferred; and

FIG. 20 illustrates an exemplary embodiment of how chain of custody is handled with using crypto currency in place of anywhere dollars.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

A “mobile device” may refer to a computing device that may be considered portable and carried by a user. Exemplary mobile devices include smart phones, tablet computers, or the like.

“Software” or “application” may refer to prescribed rules to operate a computer. Examples of software or applications may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.™, Jini.™, C, C++, Smalltalk, Python, Perl, UNIX Shell, Visual Basic or Visual Basic Script, Virtual Reality Markup Language (VRML), ColdFusion.™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order unless specifically described as such. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a consumer mobile software application is designed to entice new or infrequent visitors to visit a merchant. The application may permit the consumer to register and receive reward offers from the merchant, typically only when the consumer is at the merchant's place of business. The application may store each of the merchants added to the consumer's account and track the available rewards. The application may also store anywhere dollars, which may be usable across any of the participating merchants. The anywhere dollars may be converted into a crypto currency whose value may fluctuate based on the value of such currency. The merchants accepting such currency when redeemed by the consumer may opt to auto exchange the crypto currency to conventional currency, such as U.S. dollars when the merchant is in the U.S., on their account or may choose to retain the crypto currency itself.

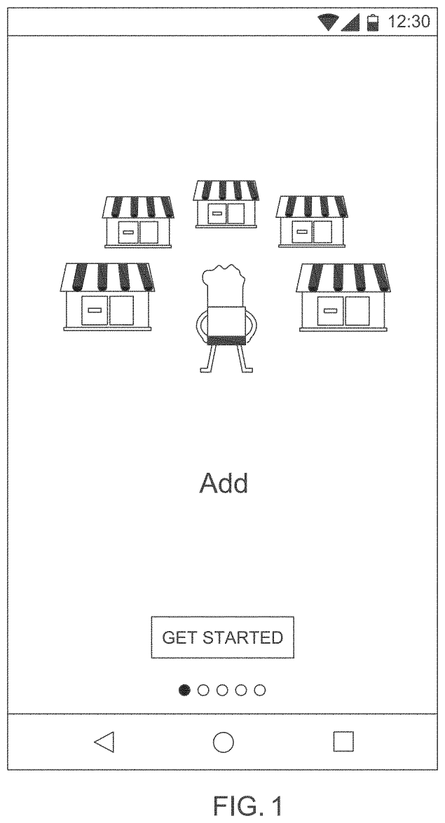

FIGS. 1 through 3 illustrate exemplary screen shots that are visible to the user upon first opening the software application. These screens may be used to describe various functions available in the application. The screens can include an “add” screen, as shown in FIG. 1, which may include text describing how a user can add a merchant to their account when they visit a merchant. In some embodiments, the application may only allow a user to add a merchant to their account when they are at the merchant. In other embodiments, as described below, a user may be permitted to add a limited number of merchants when registering for an account or may be able to add a limited number of merchants when the user receives a digest.

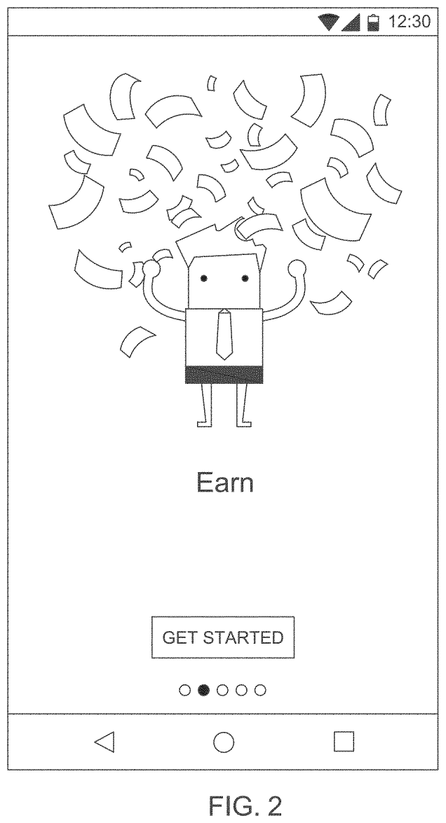

FIG. 2 shows a second descriptive screen, describing the “earn” function and how a user may earn dollars usable at merchants that have been added to their account. A similar introductory screen, not shown, may describe how a user may use anywhere dollars, also referred to as Abacus dollars. A further screen, not shown, may describe how the user may spend the merchant and anywhere dollars. Details on both the earning and spending or redeeming processes are described below.

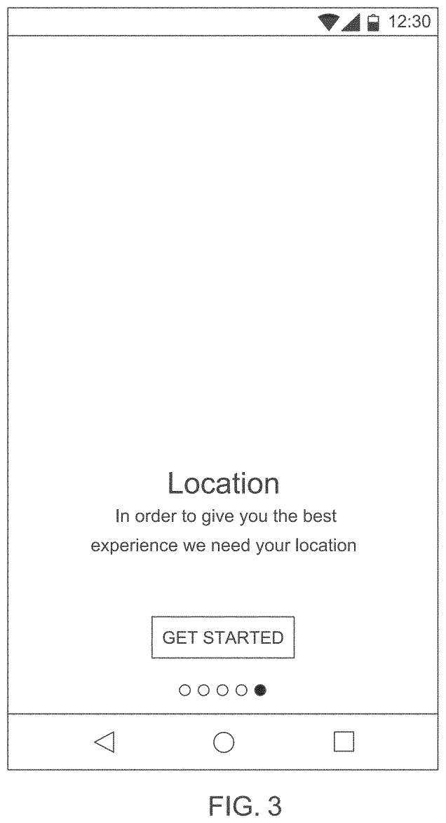

FIG. 3 shows a final descriptive screen that explains to the user that they need to permit the application to use the mobile device's location services. In some embodiments, location permission is required to use the application and the application may provide the user with details as to how and why this is required. If location permission is not established, when the user presses the get started button, the application may ask the user to allow the application to use the mobile devices location services.

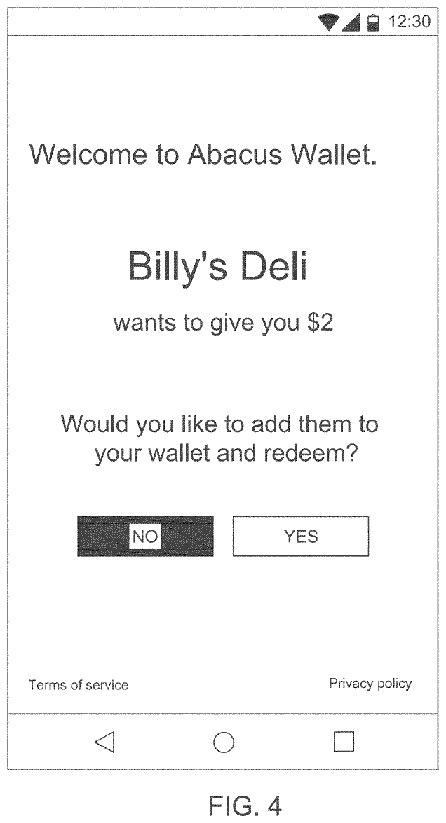

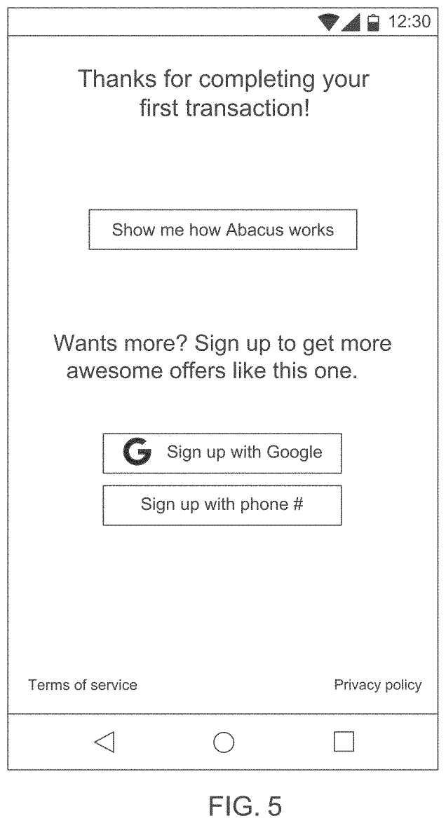

FIG. 4 shows an initial screen that may be provided to the user if they are in a participating merchant's store. The screen may identify the merchant, identify the reward available, which, in this case is two dollars of credit at Billy's Deli, and ask the user if they would like to add the merchant to their wallet and redeem the reward. If the user selects “yes”, a screen similar to that of FIG. 5 may be displayed to the user, allowing the user to view the introductory screens of FIGS. 1 through 3, as discussed above, or sign up for the application. As may be known in the art, various types of registration may be used, such as signing up with another service's identification (sign up with Google, sign up with Facebook, or the like), with one's phone number, or the like.

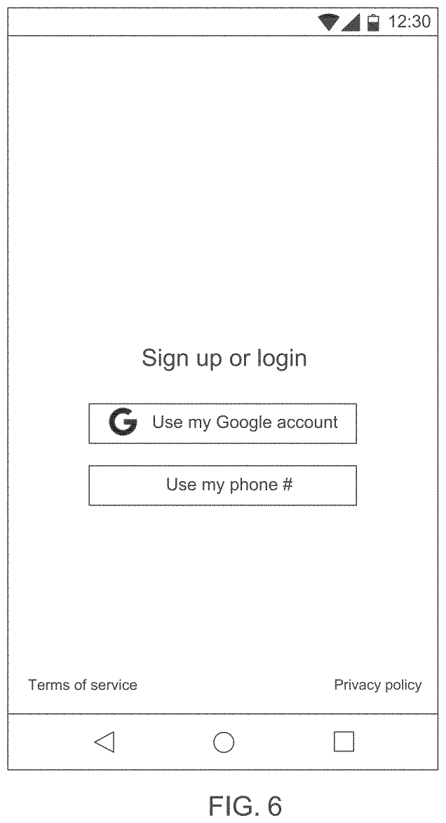

FIG. 6 shows an initial screen that may be provided to the user if they are not in a participating merchant's store when the access the application for the first time. After the introductory and location permission screens, as shown in FIGS. 1 through 3, for example, the user is asked if they would like to sign-up or login with their Google account (or other similar third-party login) or with their phone number.

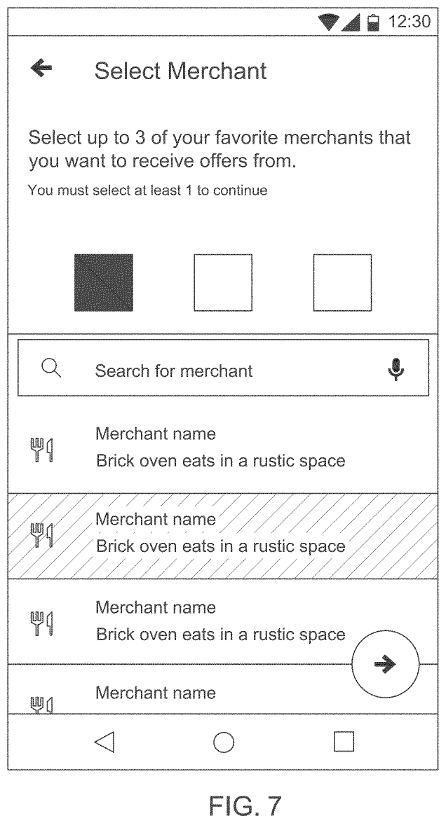

Once the user is signed up, they have the option of adding a limited number of merchants, such as three merchants, to their wallet to get started, as shown in FIG. 7. In this screen, the user can search for merchants by various manners, such as by name, distance, or the like. The user may select these merchants to add them to their account. The user may be required to add at least one merchant in order to continue with the application and permit the application to show the user's dashboard.

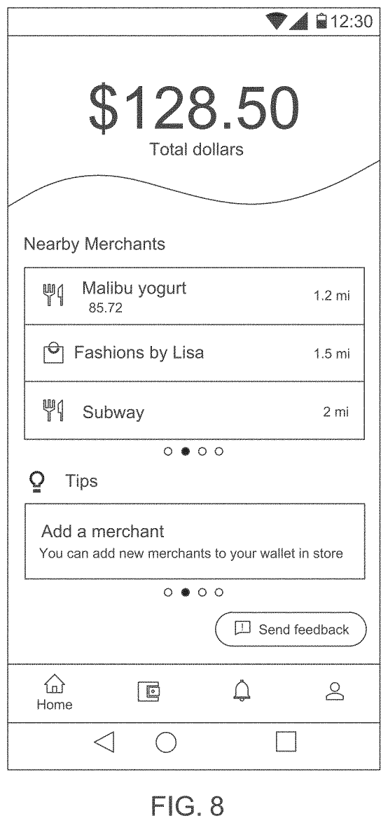

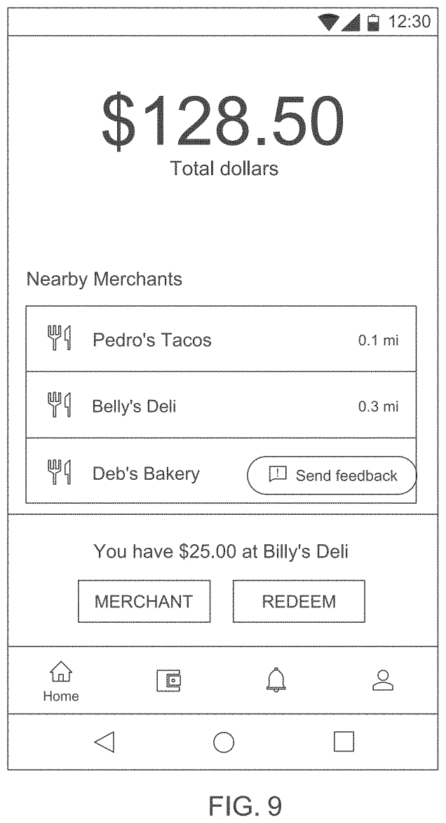

The user's dashboard, one example of which is shown in FIGS. 8 and 9, can aggregate the value of the user's account and can show an overview of all the dollars the user has in the application. It may show a list of nearby merchants as well as a list of tips to using the application. In some embodiments, the dashboard may include more gamified options to permit the user to get more dollars. The user may also access a redemption, as described below, from the dashboard.

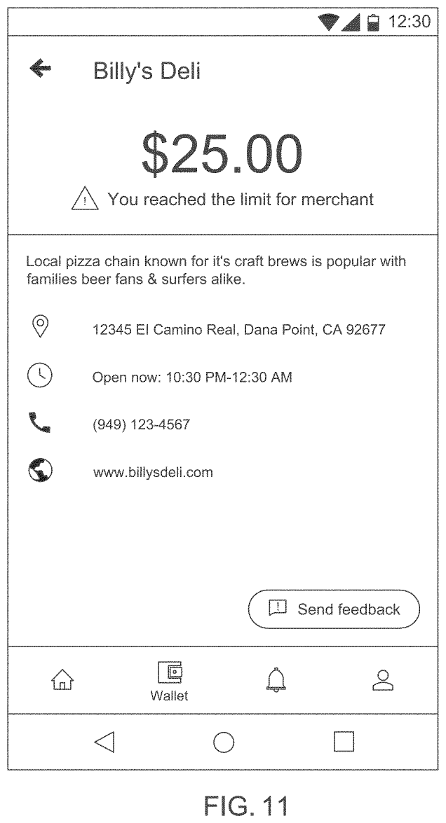

Referring now to FIG. 11, a wallet view is shown. Access to this view may be obtained, for example, by navigation through a wallet icon that may appear on the user's dashboard page. The wallet is where the user can see a full list of their merchants in their wallet. Users may also search for a specific merchant or use a “nearby” feature to search for merchants close to the user's physical location. The wallet view can show the total dollars available as well as a breakdown between Abacus dollars and Merchant dollars, where, as described above, Abacus, or anywhere dollars may be used at any merchant, while Merchant dollars are those limited for use at the specific merchants as shown in the wallet view. As seen in FIG. 11, the wallet view can show a list of all the merchants the consumer has in their wallet, which may be sorted by various mechanisms, such as by balance from highest to lowest, as shown. An icon may be shown, such as the triangle with an exclamation point therein, as shown next to Billy's Deli in FIG. 11, to indicate when the user has hit that merchant's limit. Each merchant may be clickable to provide a merchant details page, as discussed below.

In some embodiments, the user may find a complete list of their transaction history in the wallet view. Each transaction may be clickable to provide a transaction detail page. This detail page may show a breakdown of the transaction, include the transaction total, breakdown of dollars used, date, merchant, category, and the like.

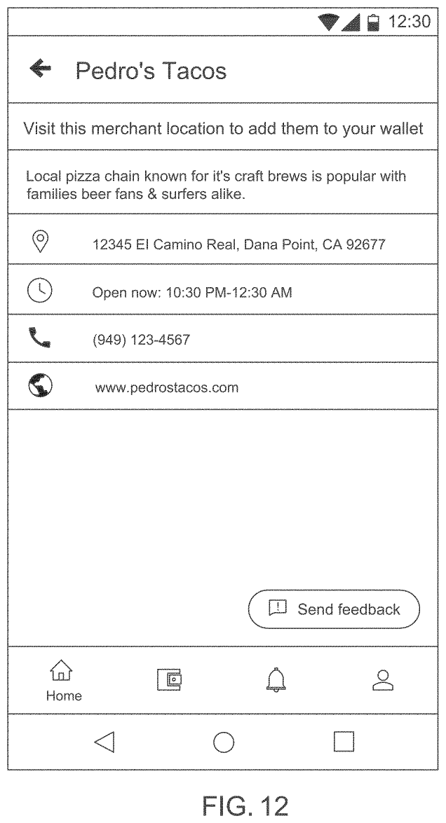

Referring to FIG. 12, an exemplary merchant details page is shown. This page is an overview of the specific merchant the user has within their network. This screen may display the merchant balance, store description, hours of operation, address, phone number, website and the like. In some embodiments, a transaction history for that particular merchant may be available. In some embodiments, reviews may be provided in this section. The merchant details page can include a running total of their balance and may include a list of transactions that the user has previously performed with the particular merchant. The user may be able to pause notifications from a particular merchant in the merchant details page and also may be able to unsubscribe from a merchant.

FIG. 12 is an exemplary screen shot showing a merchant details page for a merchant that is not added to the user's account. This screen may be similar to the added merchant details page, as described above with respect to FIG. 11, but may not, of course, include an available balance. In some embodiments, if the user previously visited this merchant, was offered dollars through the application while in the store, and did not accept the offer, the merchant details screen may include a view showing dollars available to them. The user must then visit the merchant to be able to add the merchant to their wallet and permit the offer to be available to the user.

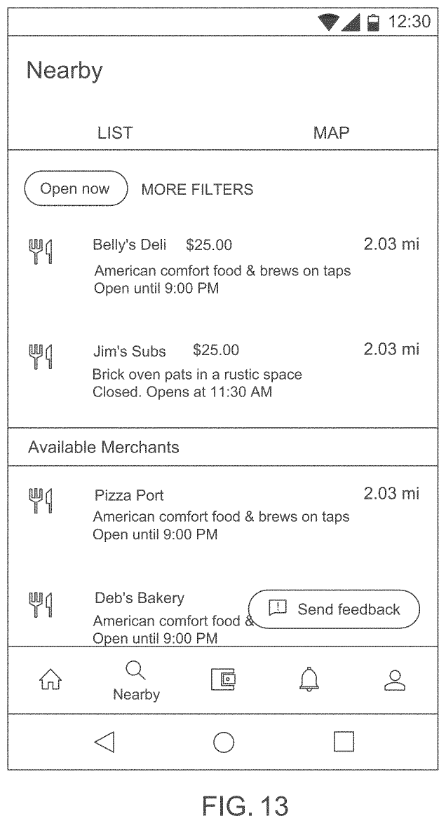

FIG. 13 is an exemplary screen shot showing functionality allowing a user to find and search for merchants—both added and unadded. The interface can provide a textual view as well as a map view to show the various merchants in the area. A filters screen may be provided to permit the user to see only specific merchants, such as those the user has added, only those unadded, or merchants of a particular category, such as grocery stores, restaurants, or the like.

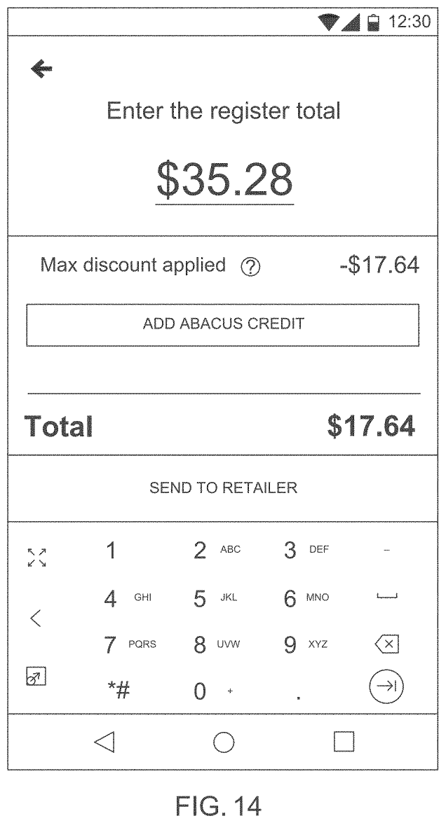

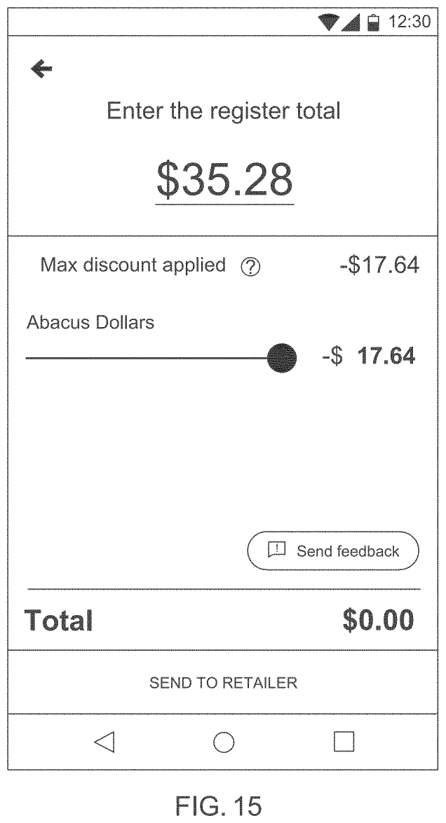

FIGS. 14 and 15 show exemplary screen shots in a redemption process. If the user is in one of their merchant details page, there may be a button appearing to permit them to redeem dollars. This button may remain on the merchant details page as long as the user is in the store. Users may also be able to reach the redeem pages via a redeem button on the dashboard adjacent the merchant they are shopping. Should a user choose to redeem dollars, they will go to through the redemption process.

First, the user can enter the transaction total into the application as shown in FIG. 14. Then, the merchant dollars discount will be automatically filled out to the maximum as shown in FIG. 15—either the maximum dollars available, or up to a set amount of the total, such as 50 percent of the transaction total. The consumer may change the automatically filled out amount if desired. The user may also choose to apply Abacus dollars, as desired. In some embodiments, the user can add Abacus dollars up to the total of the transaction. In other embodiments, the total discounts and Abacus dollars may be limited to a percent of the transaction total. Once complete, the user can click on a button to send the transaction to the retailer. The merchant may receive the details of the redemption on a merchant terminal, which may be a smart device, computing device, mobile device, or the like. The transaction may be sent via one or more wireless protocols, such as Wi-Fi, near field communication (NFC), Bluetooth, wireless cellular data (such as 3G, 4G, LTE, or the like), or other communication method as may be known in the art.

After the transaction is complete, the user can be taken to the merchant details page so they are able to see their new balance and transaction history. In some embodiments, the user may be provided an option to review the merchant after a transaction is completed. Such reviews may be provided to other users, where these users would understand that such reviews are based on an actual transaction at the merchant.

As shown in FIG. 8, for example, the user dashboard page can include a button for the user to review their notifications. Notifications, as discussed below, may be from the merchant or from the software provider. The notification center icon can display a badge with a number inside, for example, to show the user how many notifications are pending to be reviewed by the user. Once the user reviews their notifications, this badge may be cleared and no longer be displayed. In some embodiments, notifications may purge after a given number of days.

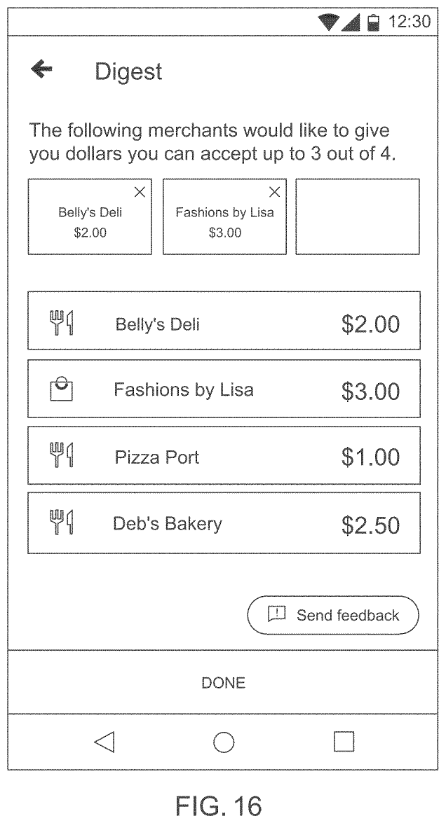

As shown in FIG. 16, in some embodiments, users may receive a list of offers from merchants which the user can either accept or decline. Upon acceptance, the offers can be purged and stored as dollars in the wallet. In some embodiments, the receipt of a digest in the application can trigger a notification on the mobile device as well as within the application. In some embodiments, a user may select a limited number, such as three, of the offers presented in the digest.

Offers, such as those delivered in the digest, those presented to the user while in the merchant's business, or the like, may not be delivered to all users of the application. In some embodiments, the application may only send offers to new or infrequent visitors. As used herein, the term “infrequent” can refer to a customer of a business who visits the business less than a preset maximum, spends less than a present maximum amount at the business or spends less than a present amount of time at the business. For example, an infrequent visitor may be defined as a customer that hasn't visited the business over the past 10 days. In some embodiments, the merchant may be able to set the definition of an infrequent visitor by defining a number of days since last visit, a dollar amount spent in the past given number of days, or how many minutes spent in the business in the past given number of days, for example.

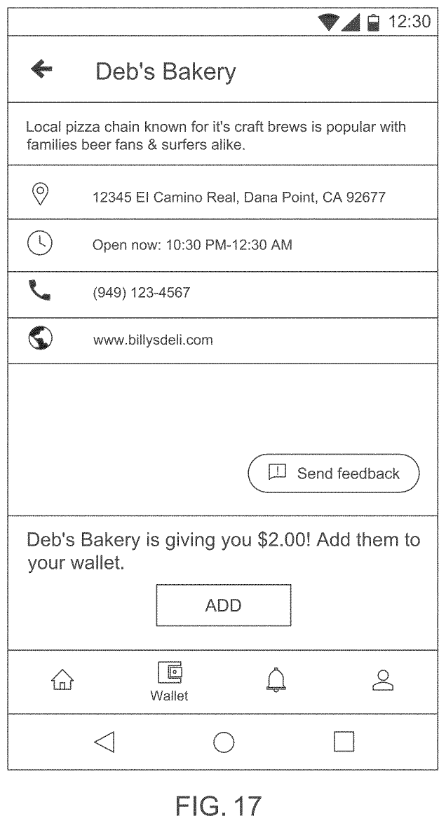

In some embodiments, outside of the initial user registration, users may be required to be in a store to receive an offer from a merchant or add that merchant to their account. In some embodiments, if the user is in a merchant's store and have not added the merchant to their account for a predetermined period of time, such as 90 seconds, the user can receive a phone notification asking if they would like to add the merchant. This phone notification will be cleared once the user leaves the store, however, a notification may remain in the notification center of the application. FIG. 17 shows an example of a screen shot from the user's notifications where the user visited Deb's Bakery but did not add the merchant. In some embodiments, the application may allow the user to add the merchant within a predetermined period of time since their visit, such as within two days. In other embodiments, the user must re-visit the merchant to add the merchant and accept the offer for discount dollars. In some embodiments, if a user does not accept offers from a merchant after getting a certain number of offers therefrom, such as after three offers, the user may no longer receive offers from that merchant. If the user re-visits the merchant later, the user may be provided with a notification asking if they would like to receive offers from that merchant again.

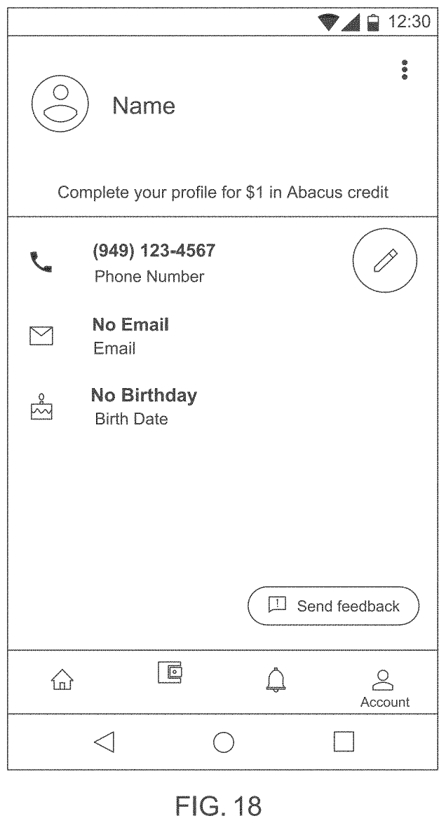

Other methods may be provided to the user to earn merchant dollars or Abacus/anywhere dollars. For example, a merchant may send an offer for merchant dollars at their business, where the award of the dollars is contingent upon the user viewing a video, taking a survey, or the like. Similarly, the application could offer the user the opportunity to earn anywhere dollars by doing the same. Furthermore, as shown in FIG. 18, a user may review their registration information and may be offered Abacus dollars for completing their profile within the application. Similarly, there may be provided options for users to refer other users to earn Abacus dollars. Other options, as may be known in the art, may be provided for users to earn either merchant dollars or Abacus dollars.

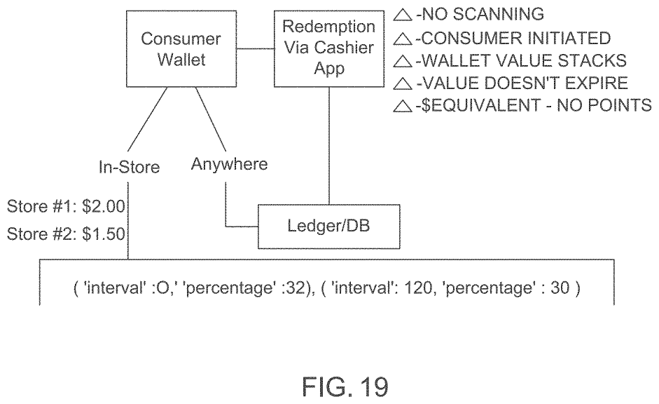

FIG. 19 shows how the discount currency, such as Abacus dollars, are stored and transferred. The delta's shown in the Figure represent differences from conventional loyalty and digital wallets as discussed above. Also, the sequence represents a small portion of how the database may calculate discount value distribution. All of it is transferred or redeemed via a consumer-initiated process and transfers through a merchant side “cashier app” that communicates back to a ledger and updates all devices on the account.

From the merchant's perspective, redeemed Abacus dollars may be payable to the merchant when a user uses them in a transaction. In some embodiments, the merchants may have an account credited for the dollar value of the Abacus dollars redeemed.

In some embodiments, the Abacus dollars in a user's account may be converted to a crypto currency, such as Bitcoin, for example. This would allow the user to watch their “Abacus dollar” value fluctuate with the fluctuations in the trading of the crypto currency. During a redemption, the user may see the dollar equivalent (based on current crypto currency trading) of their balance to apply to a transaction. The merchant may choose either to hold the crypto currency itself in their merchant account after a user redemption of Abacus dollars, or may choose an auto exchange, where the crypto currency is automatically exchanged for its dollar equivalent and deposited into the merchant's account.

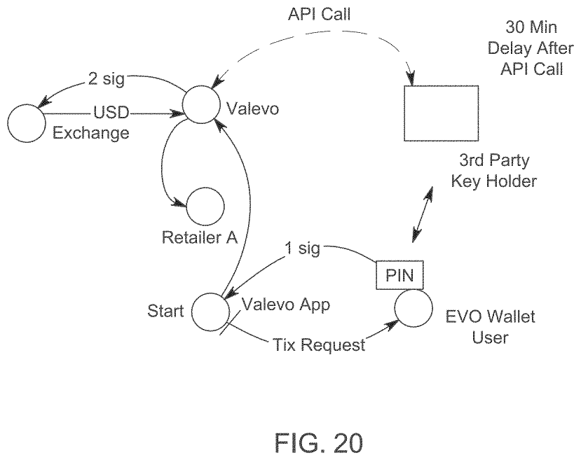

As discussed above, embodiments of the present invention provide the ability to replace the Anywhere Value (Abacus dollar value) with a Crypto Currency or virtually any other recognized currency. FIG. 20 illustrates one embodiment how chain of custody is handled when using crypto currency in place of anywhere currency.

Embodiments of the present invention provide a way to transfer “value” irrespective of its structure from people to businesses and from businesses to people. Moreover, embodiments of the present invention provide the ability to see on a map how much redeemable “value” a user has at a particular business. Embodiments of the present invention further provide the ability to receive unique offers (value amounts) pre-determined by a combination of time since last visit, % of maximum value a business is willing to give out per individual, time since last redemption in-store, and shopping behaviors, i.e., where the user has or has not been visiting.

In some embodiments, a very specific two-signature verification crypto wallet can be created within the software application so the issue of transferring “value” and redeeming “value” via the software application can be handled without the introduction of crypto terminology.

As discussed above, the application of the present invention is not designed to be a loyalty reward program, but instead, to provide motivation for infrequent customers to visit a business. By analyzing the behaviors of the user, the user may be identified as an infrequent customer, as discussed above. Once established as such, the user may receive offers from the consumer either while at the merchant's store, or via a periodic digest.

In some embodiments, the application of the present invention does not use credit cards or store such data. The application is used to store merchant reward offers in the form of possible credits against a transaction, for multiple merchants. Payments made through the application against a transaction may be in the form of merchant dollars and/or Abacus dollars that are stored in the application. In some embodiments, no other form of payment is provided through the application.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for attracting an infrequent customer to a business, the method comprising:
prompting the customer to install a software application on a mobile device;
sending a notification of a discount offer from a merchant to the mobile device via the software application when the customer is at the merchant when it is determined that the customer visits the merchant infrequently, wherein a determination of whether the customer visits the merchant infrequently is provided by one or more predetermined matrices;
storing the discount offer in a wallet of the software application if the customer accepts the discount offer, wherein the wallet is configured to store and compile multiple offers from multiple merchants; and
storing anywhere dollars in the wallet of the software application, wherein anywhere dollars are redeemable at any of the multiple merchants of the customer.

2. The method of claim 1, further comprising a dashboard page provided by the software application and displayed to the consumer, the dashboard page including a view of the total value of the discount offers and anywhere dollars available in an account of the consumer.

3. The method of claim 2, wherein the dashboard page includes a view of nearby merchants.

4. The method of claim 1, wherein the wallet displays a value of the discount offers and anywhere dollars available for each merchant added to the wallet.

5. The method of claim 1, further comprising a merchant details page available for display by the software application, the merchant details page providing the consumer with information about the merchant and, if the merchant is added to the consumer's wallet, a value of discount offers redeemable at the merchant.

7. The method of claim 1, further comprising a redemption page, wherein the consumer is prompted to enter the total of a transaction and is prompted to apply available discount offers and anywhere dollars.

8. The method of claim 1, further comprising periodically sending a digest of discount offers to the consumer via the software application, the discount offers sent to the consumer include merchants at which the consumer visits infrequently.

9. The method of claim 1, wherein the one or more predetermined matrices include at least one of time at the merchant, dollars spent at the merchant and number of visits to the merchant over a given period of time.

10. The method of claim 1, wherein the anywhere dollars in the wallet of the consumer are provided in a crypto currency.

11. The method of claim 10, wherein the merchant receiving crypto currency in a redemption from the consumer, has an option to auto exchange the crypto currency to conventional currency or to receive shares of crypto currency into a merchant account.

12. A mobile software application disposed on a tangible computer readable medium within a mobile device, the software application including program code configured to perform the following steps:
prompting the customer to install the software application on the mobile device;
sending a notification of a discount offer from a merchant to the mobile device via the software application when the customer is at the merchant when it is determined that the customer visits the merchant infrequently, wherein a determination of whether the customer visits the merchant infrequently is provided by one or more predetermined matrices;
storing the discount offer in a wallet of the software application if the customer accepts the discount offer, wherein the wallet is configured to store and compile multiple offers from multiple merchants;
storing anywhere dollars in the wallet of the software application, wherein anywhere dollars are redeemable at any of the multiple merchants of the customer;
displaying, via the software application, a dashboard page to the consumer, the dashboard page including a view of the total value of the discount offers and anywhere dollars available in an account of the consumer;
displaying, via the software application, nearby merchants;
displaying, via the software application, a wallet view page showing a value of the discount offers and anywhere dollars available for each merchant added to the wallet; and
displaying, via the software application, a merchant details page providing the consumer with information about the merchant and, if the merchant is added to the consumer's wallet, a value of discount offers redeemable at the merchant.

13. The software application of claim 12, wherein the software application includes program code configured to provide a redemption page, wherein the consumer is prompted to enter the total of a transaction and is prompted to apply available discount offers and anywhere dollars.

14. The software application of claim 12, wherein the software application includes program code configured to periodically send a digest of discount offers to the consumer via the software application, the discount offers sent to the consumer include merchants at which the consumer visits infrequently.

15. The software application of claim 12, wherein the one or more predetermined matrices include at least one of time at the merchant, dollars spent at the merchant and number of visits to the merchant over a given period of time.

16. The software application of claim 12, wherein the anywhere dollars in the wallet of the consumer are provided in a crypto currency, and wherein the merchant receiving crypto currency in a redemption from the consumer, has an option to auto exchange the crypto currency to conventional currency or to receive shares of crypto currency into a merchant account.

17. A method for attracting an infrequent customer to a business, the method comprising:
prompting the customer to install a software application on a mobile device;
sending a notification of a discount offer from a merchant to the mobile device via the software application when the customer is at the merchant when it is determined that the customer visits the merchant infrequently, wherein a determination of whether the customer visits the merchant infrequently is provided by one or more predetermined matrices;
storing the discount offer in a wallet of the software application if the customer accepts the discount offer, wherein the wallet is configured to store and compile multiple offers from multiple merchants;
storing anywhere dollars in the wallet of the software application, wherein anywhere dollars are redeemable at any of the multiple merchants of the customer;
displaying a dashboard page provided by the software application, the dashboard page including a view of the total value of the discount offers and anywhere dollars available in an account of the consumer;
displaying a wallet view provided by the software application, the wallet view displaying a value of the discount offers and anywhere dollars available for each merchant added to the wallet;
displaying a merchant details page available by the software application, the merchant details page providing the consumer with information about the merchant and, if the merchant is added to the consumer's wallet, a value of discount offers redeemable at the merchant;
displaying a redemption page by the software application, wherein the consumer is prompted to enter the total of a transaction and is prompted to apply available discount offers and anywhere dollars to the transaction at the merchant; and
periodically sending a digest of discount offers to the consumer via the software application, the discount offers sent to the consumer include merchants at which the consumer visits infrequently.

18. The method of claim 17, wherein the one or more predetermined matrices include at least one of time at the merchant, dollars spent at the merchant and number of visits to the merchant over a given period of time.

19. The method of claim 17, wherein:
the anywhere dollars in the wallet of the consumer are provided in a crypto currency; and
the merchant receiving crypto currency in a redemption from the consumer, has an option to auto exchange the crypto currency to conventional currency or to receive shares of crypto currency into a merchant account.
